(19) United States
(12) Patent Application Publication
(10) Pub. No.: US 2024/0331896 A1
(43) Pub. Date: Oct. 3, 2024

(54) ELECTRONIC PART

(71) Applicant: ROHM CO., LTD., KYOTO (JP)

(72) Inventor: ANOUSH KANAMORI, KYOTO (JP)

(21) Appl. No.: 18/614,151

(22) Filed: Mar. 22, 2024

(30) Foreign Application Priority Data
Mar. 27, 2023 (JP) 2023-050132

(51) Int. Cl. H01C 1/14; H01C 1/16

(52) U.S. Cl. CPC H01C 1/14; H01C 1/16

(57) ABSTRACT

The present disclosure provides an electronic part. The electronic part includes: a substrate, having a first main surface; a first external terminal and a second external terminal, formed on the first main surface and spaced apart from each other; and a resistive circuit portion, formed on the first main surface and electrically connected to the first external terminal and the second external terminal. The resistive circuit portion includes: a first wiring, formed on the first main surface and to which the first external terminal is electrically connected; a second wiring, formed on the first main surface and electrically connected to the second external terminal; and a first and second resistor unit that are electrically connected to the first wiring and the second wiring. A length of the second resistor unit along the first direction is less than a length of the first resistor unit along the first direction.

### TECHNICAL FIELD

The present disclosure relates to an electronic part.

### BACKGROUND

A chip resistor including a substrate and a resistive circuit grid formed on the substrate (for example, referring to patent document 1) is known as a type of an electronic part. The resistive circuit grid includes a plurality of resistors, and forms a plurality of resistive units by electrical connections of one or more resistors. These resistive units are connected in a predetermined manner using connection conductive films and fuse films. In addition, by selectively blowing the fuse films, the resistive units can be set in either of a state in which they are assembled in the resistive circuit grid and a state in which they are separated from the resistive circuit grid. Thus, a resistance value of the resistive circuit grid can be set as a required resistance value.

### PRIOR ART DOCUMENT

### Patent Publication

[Patent document 1] Japan Patent Publication No. 2013-153129

### BRIEF DESCRIPTION OF THE DRAWINGS

FIG. 1 is a brief perspective diagram of an electronic part of a first embodiment.

FIG. 2 is a brief side view of a state of the electronic part in FIG. 1 mounted on a circuit substrate.

FIG. 3 is a brief plan diagram of the electronic part in FIG. 1.

FIG. 4 is a brief cross-sectional diagram of an electronic part cut along the line F4-F4 in FIG. 3.

FIG. 5 is an enlarged brief plan view of a resistive element and its periphery of the electronic part in FIG. 3.

FIG. 6 is an enlarged brief plan view of a resistive element and its periphery in a state in which fuses are blown.

FIG. 7 shows a brief cross-sectional diagram of an electronic part in a step of blowing fuses.

FIG. 8 is an equivalent circuit diagram of a resistive circuit portion in an electronic part.

FIG. 9 is an enlarged brief plan view of a resistive element and its periphery of the electronic part according to a second embodiment.

FIG. 10 is an enlarged brief plan view of a resistive element and its periphery of the electronic part according to a third embodiment.

FIG. 11 is an enlarged brief plan view of a resistive element and its periphery of the electronic part according to a fourth embodiment.

FIG. 12 is an enlarged brief plan view of a resistive element and its periphery of the electronic part according to a fifth embodiment.

FIG. 13 is an enlarged brief plan view of a resistive element and its periphery of the electronic part of a variation example.

### DETAILED DESCRIPTION OF THE EMBODIMENTS

Several embodiments of an electronic part of the present disclosure are described with the accompanying drawings below. Moreover, to keep the description clear and simple, the constituting elements shown in the accompanying drawings are not necessarily drawn in constant scales. Moreover, for better understanding, shading lines may be omitted from the cross-sectional views. It should be noted that the drawings are for illustrating the embodiments of the present disclosure, and are not to be construed as limitations to the present disclosure.

The description below includes details for specifically implementing a device, a system and a method of the exemplary embodiments of the present disclosure. The detailed description is intended for illustration purposes and is not to be construed as limitations to the embodiments of the present disclosure or applications or usages of these embodiments.

Moreover, in the description below, an expression “a width of a part A is equal to a width of a part B” refers to that a difference between a length of the part A and a length of the part B is within 10% of the length of the part A. An expression “the length of the part A is equal to the length of the part B” refers to that a difference between the width of the part A and the width of the part B is within 10% of the width of the part A.

### First Embodiment

### [Overall Configuration of Electronic Part]

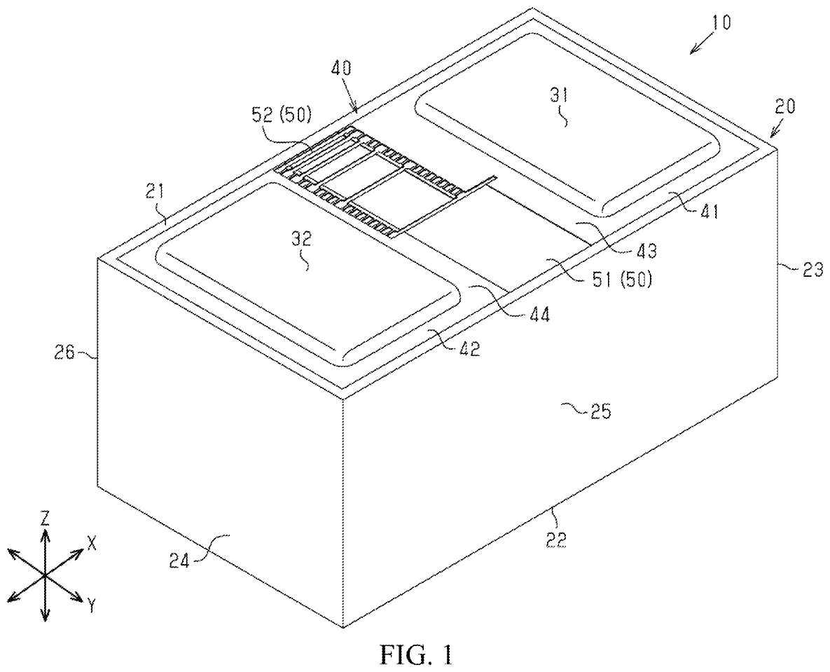

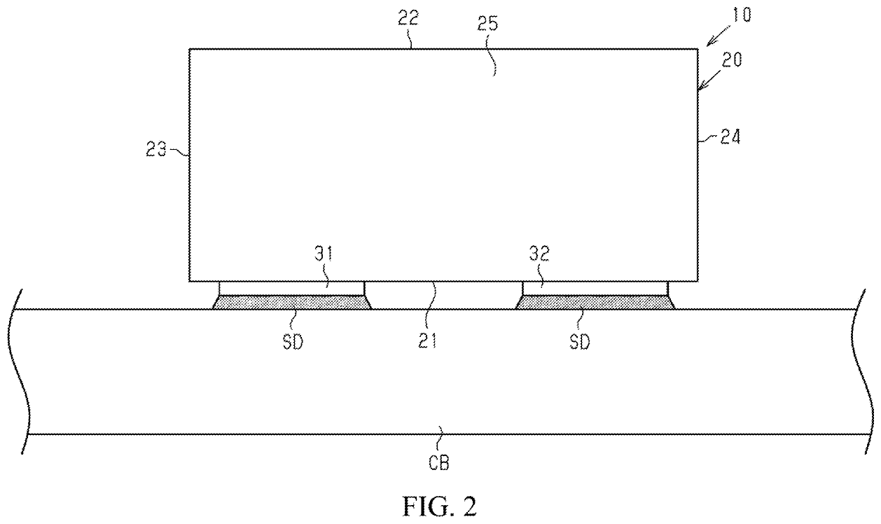

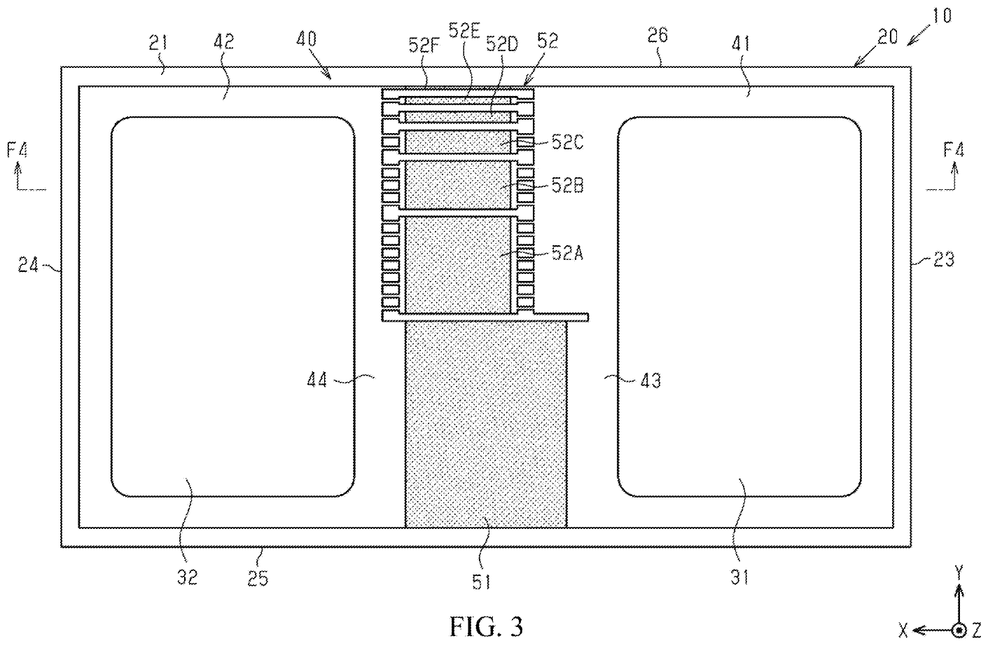

Referring to FIG. 1 to FIG. 3, an example of an overall configuration of an electronic part 10 is described below. FIG. 1 shows a schematic perspective diagram of a structure of the electronic part 10. FIG. 2 shows a schematic side view of the structure of the electronic part 10 in an assembled state. FIG. 3 shows a schematic plan view of the structure of the electronic part 10. Moreover, for better understanding, a surface insulating layer 63 and a protection layer 64 to be described later are omitted from FIG. 1 and FIG. 3.

A Z direction of X, Y and Z axes orthogonal to one another in FIG. 1 corresponds to a thickness direction of the electronic part 10. Moreover, the term such as “a plan view” used herein refers to observing the electronic part 10 along the Z-axis direction, unless otherwise specified.

As shown in FIG. 1, in the first embodiment, the electronic part 10 is configured as a chip resistor. The chip resistor is obtained by forming a plurality of chip resistors in grids on a piece of wafer, and then cutting and separating the wafer into the individual chip resistors.

The electronic part 10 includes a substrate 20, and a first external terminal 31, a second external terminal 32 and a resistive circuit portion 40 disposed on the substrate 20.

The substrate 20 is formed as a rectangular shape having the Z direction as a thickness direction. In the example in FIG. 1, in a plan view, the substrate 20 is formed to have a rectangular shape with the X direction as a long-side direction and the Y direction as a short-side direction. In one example, a size of the substrate 20 along the X direction is about 0.3 mm, a size of the substrate 20 along the Y direction is about 0.15 mm, and a thickness of the substrate 20 is about 0.1 mm.

The substrate 20 is formed of, for example, a semiconductor substrate. The semiconductor substrate can be implemented by, for example, a silicon (Si) substrate. In one example, the substrate 20 is a non-doped Si substrate. Moreover, the substrate 20 is not limited to being a semiconductor substrate, and can also be an insulative substrate such as a ceramic substrate or a glass substrate. In addition, the substrate 20 can also be a resin film.

The substrate 20 has a first main surface 21 and a second main surface 22 facing opposite sides to each other along the Z direction, and first to fourth side surfaces 23 to 26 connecting the first main surface 21 and the second main surface 22. The first side surface 23 and the second side surface 24 form two end surfaces of the substrate 20 along the X direction, and the third side surface 25 and the fourth side surface 26 form two end surfaces of the substrate 20 along the Y direction.

The first external terminal 31 and the second external terminal 32 are spaced apart from each other on the first main surface 21 of the substrate 20 along the X direction. In the example in FIG. 1, the first external terminal 31 is arranged to be closer to the first side surface 23 than a center of the first main surface 21 along the X direction. The second external terminal 32 is arranged to be closer to the second side surface 24 than the center of the first main surface 21 along the X direction.

Each of the first external terminal 31 and the second external terminal 32 functions as an external connection electrode connected to a conductor such as an external circuit pattern. As shown in FIG. 2, when the electronic part 10 is mounted on a circuit substrate CB, each of the first external terminal 31 and the second external terminal 32 is electrically connected to a circuit pattern (omitted from the drawing) of the circuit substrate CB by a conductive bonding material SD. The conductive bonding material SD is, for example, solder paste. Moreover, by serving as external connection electrodes, the first external terminal 31 and the second external terminal 32 are preferably formed of gold (Au) or have electrode surfaces plated with gold, so as to improve solder wettability and enhance reliability.

As shown in FIG. 1 and FIG. 3, in the plan view, a shape of each of the first external terminal 31 and the second external terminal 32 is, for example, a rectangular shape having the X direction as a short-side direction and the Y direction as a long-side direction. Sizes of the first external terminal 31 along the X direction and the Y direction are, for example, equal to sizes of the second external terminal 32 along the X direction and the Y direction. Moreover, the shapes and the sizes of the first external terminal 31 and the second external terminal 32 in the plan view can be modified as desired.

The resistive circuit portion 40 includes a first wiring 41, a second wiring 42 and a resistive element 50 formed on the first main surface 21 of the substrate 20.

The first wiring 41 is electrically connected to the first external terminal 31. The first wiring 41 is arranged to be closer to the first side surface 23 than the center of the first main surface 21 along the X direction. In the plan view, the first wiring 41 is arranged at a position overlapping the first external terminal 31. In the plan view, a size of the first wiring 41 along the X direction is more than the size of the first external terminal 31 along the X direction, and a size of the first wiring 41 along the Y direction is more than the size of the first external terminal 31 along the Y direction. It can be said that the first external terminal 31 is arranged on the first wiring 41.

The second wiring 42 is spaced apart from the first wiring 41 along the X direction. The second wiring 42 is electrically connected to the second external terminal 32. The second wiring 42 is arranged to be closer to the second side surface 24 than the center of the first main surface 21 along the X direction. In the plan view, the second wiring 42 is arranged at a position overlapping the second external terminal 32. In the plan view, a size of the second wiring 42 along the X direction is more than the size of the second external terminal 32 along the X direction, and a size of the second wiring 42 along the Y direction is more than the size of the second external terminal 32 along the Y direction. It can be said that the second external terminal 32 is arranged on the second wiring 42. In the example shown in FIG. 3, the size of the second wiring 42 along the Y direction is equal to the size of the first wiring 41 along the Y direction.

The resistive element 50 is formed between the first wiring 41 and the second wiring 42 along the X direction. The resistive element 50 is electrically connected to the first wiring 41 and the second wiring 42. In the example shown in FIG. 3, a size of the resistive element 50 along the Y direction is equal to the size of the first wiring 41 along the Y direction (the size of the second wiring 42 along the Y direction). Moreover, the size of the resistive element 50 along the Y direction can be modified as desired. In one example, the size of the resistive element 50 along the Y direction can be less than the size of the first wiring 41 along the Y direction (the size of the second wiring 42 along the Y direction).

### [Cross-Sectional Structure of Electronic Part]

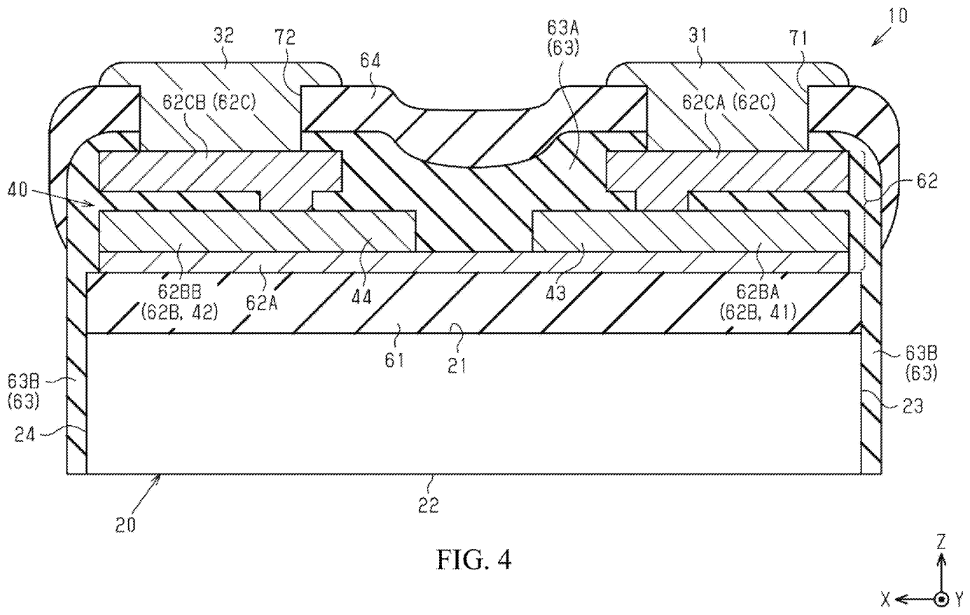

Referring to FIG. 4, a cross-sectional structure of the electronic part 10 is described below. FIG. 4 shows a schematic diagram of a cross-sectional structure of the electronic part 10 cut along the line F4-F4 in FIG. 3.

As shown in FIG. 4, the electronic part 10 primarily includes a substrate insulating layer 61, an element stack portion 62, a surface insulating layer 63 and a protection layer 64 laminated on the first main surface 21 of the substrate 20.

The substrate insulating layer 61 is formed between the first main surface 21 of the substrate 20 and the element stack portion 62 along the Z direction. The substrate insulating layer 61 is a layer that insulates the substrate 20 from the element stack portion 62. The substrate insulating layer 61 can be formed throughout an entirety of the first main surface 21. The substrate insulating layer 61 is formed by a laminated structure of one or more insulating films. The substrate insulating layer 61 includes, for example, at least one of a silicon oxide (SiO₂) film and a silicon nitride (SiN) film. In one example, the substrate insulating layer 61 is formed by a SiO₂ film. Moreover, when an insulating substrate or a resin film is used as the substrate 20, the substrate insulating layer 61 can be omitted.

The element stack portion 62 is a portion that forms the resistive element 50, the first wiring 41 and the second wiring 42, and is formed by, for example, a laminated structure of a plurality of conductive films. In one example, the element stack portion 62 includes a resistive film 62A, a first conductive film 62B and a second conductive film 62C. The resistive film 62A, the first conductive film 62B and the second conductive film 62C are sequentially laminated from a side of the substrate 20 (the substrate insulating layer 61).

The resistive film 62A is in contact with the substrate insulating layer 61 on the substrate insulating layer 61. The resistive film 62A is formed, for example, nearly throughout an entirety of a surface of the substrate insulating layer 61. The resistive film 62A is formed by a laminated structure of one or more resistive films. The resistive film 62A includes, for example, at least one of a titanium nitride (TiN) film, a titanium oxynitride (TiON) film, and a titanium silicon oxynitride (TiSiON) film.

The first conductive film 62B is a conductive film forming the first wiring 41 and the second wiring 42. The first conductive film 62B is in contact with the resistive film 62A on the resistive film 62A. In the example in FIG. 4, the first conductive film 62B is formed as two in quantity separated from each other along the X direction. In the description below, for the sake of brevity, the two first conductive films 62B are referred to as “a first conductive film 62BA”, and “a first conductive film 62BB”. The first conductive film 62BA is arranged to be closer to the first side surface 23 than a center of the substrate 20 along the X direction. The first conductive film 62BB is arranged to be closer to the second side surface 24 than the center of the substrate 20 along the X direction. That is to say, the first conductive film 62BA is a conductive film forming the first wiring 41, and the first conductive film 62BB is a conductive film forming the second wiring 42.

The resistive film 62A is exposed between the first conductive film 62BA and the first conductive film 62BB along the X direction. The exposed resistive film 62A forms the resistive element 50. That is to say, the resistive element 50 is disposed between the first wiring 41 and the second wiring 42 in the resistive film 62A along the X direction, and corresponds to a part that electrically connects the first wiring 41 and the second wiring 42.

The first conductive films 62BA and 62BB have a thickness more than that of the resistive film 62A. The first conductive films 62BA and 62BB are formed to have a resistance value less than that of the resistive film 62A. That is to say, the first conductive films 62BA and 62BB are formed for a current to flow through more easily than that in the resistive film 62A. The first conductive films 62BA and 62BB are formed of, for example, a material containing at least one of aluminum (Al) and copper (Cu). In one example, the first conductive films 62BA and 62BB are formed of an AlCu alloy.

Since the resistance values of the first wiring 41 and the second wiring 42 are less than that of the resistive film 62A, compared to the resistive film 62A, a current flows more easily toward the first wiring 41 (the first conductive film 62BA) and the second wiring 42 (the first conductive film 62BB). Because the first wiring 41 and the second wiring 42 are physically separated and are electrically connected by the resistive film 62A, for example, a current flowing through the first wiring 41 flows to the second wiring 42 through the resistive film 62A (the resistive element 50). Since the resistance value of the second wiring 42 is less than that of the resistive film 62A, compared to the resistive film 62A, a current flows into the second wiring 42.

The second conductive film 62C is a conductive film connecting the first conductive film 62B with the first external terminal 31 and the second external terminal 32. The second conductive film 62C includes a part in contact with the first conductive film 62B on the first conductive film 62B. On the other hand, in the example shown in FIG. 4, the second conductive film 62C includes an opposing part separated by the first conductive film 62B along the Z direction. Moreover, the second conductive film 62C can also be formed to be entirely and directly connected to the first conductive film 62B

In the example shown in FIG. 4, the second conductive film 62C is formed as two in quantity separated from each other along the X direction. The first conductive film 62B and the resistive film 62A are exposed between the two second conductive films 62C along the X direction. In the description below, for the sake of brevity, the two second conductive films 62B are referred to as “a second conductive film 62CA”, and “a second conductive film 62CB”. The second conductive film 62CA is in contact with the first conductive film 62BA on the first conductive film 62BA. The second conductive film 62CB is in contact with the first conductive film 62BB on the first conductive film 62BB.

The second conductive films 62CA and 62CB are formed of, for example, a material containing at least one of Al and Cu. In one example, the second conductive films 62CA and 62CB are formed of an AlCu alloy. That is to say, the second conductive films 62CA and 62CB can be formed of the material same as the first conductive films 62BA and 62BB. In one example, the second conductive films 62CA and 62CB have a thickness more than that of the resistive film 62A.

The surface insulating layer 63 is formed throughout an entirety of the first main surface 21 of the substrate 20 in the plan view. More specifically, the surface insulating layer 63 is formed on the substrate insulating layer 61, and the substrate insulating layer 61 is formed on the first main surface 21. The surface insulating layer 63 is in contact with the element stack portion 62 on the element stack portion 62. That is to say, the surface insulating layer 63 covers the element stack portion 62. Moreover, the surface insulating layer 63 covers the first to fourth side surfaces 23 to 26 of the substrate 20. As such, the surface insulating layer 63 includes an element insulating layer 63A covering the element stack portion 62, and a side insulating layer 63B covering throughout an entirety of the first to fourth side surfaces 23 to 26. The side insulating layer 63B has a thickness, for example, less than that of the element insulating layer 63A. The surface insulating layer 63 is formed of, for example, a SiN film.

The protection layer 64 is formed throughout an entirety of the first main surface 21 of the substrate 20 in the plan view. The protection layer 64 is in contact with the element insulating layer 63A on the element insulating layer 63A of the surface insulating layer 63. That is to say, the protection layer 64 covers the element insulating layer 63A. On the other hand, the protection layer 64 is formed to be not closer to the second main surface 22 of the substrate 20 than the first main surface 21 of the substrate 20 along the Z direction. That is to say, the protection layer 64 does not cover the side insulating layer 63B of the surface insulating layer 63. The protection layer 64 is formed of, for example, a resin material. In one example, the protection layer 64 is formed of polyimide (PI).

A first opening 71 and a second opening 72 individually exposing the second conductive films 62CA and 62CB are formed on the protection layer 64 and the element insulating layer 63A of the surface insulating layer 63. The first opening 71 passes through the protection layer 64 and the element insulating layer 63A along the Z direction and accordingly exposes a portion of the second conductive film 62CA. The second opening 72 passes through the protection layer 64 and the element insulating layer 63A along the Z direction and accordingly exposes a portion of the second conductive film 62CB.

The first external terminal 31 is disposed to fill the first opening 71 in the first opening 71. The first external terminal 31 is formed to be in contact with the second conductive film 62CA via the first opening 71 on the second conductive film 62CA.

The second external terminal 32 is disposed to fill the second opening 72 in the second opening 72. The second external terminal 32 is formed to be in contact with the second conductive film 62CB on the second conductive film 62CB.

The first external terminal 31 and the second external terminal 32 can be formed of a known electrode material. The electrode material is, for example, a laminated structure (NiPdAu) of nickel (Ni), palladium (Pd) and Au.

### [Configuration of Resistive Element]

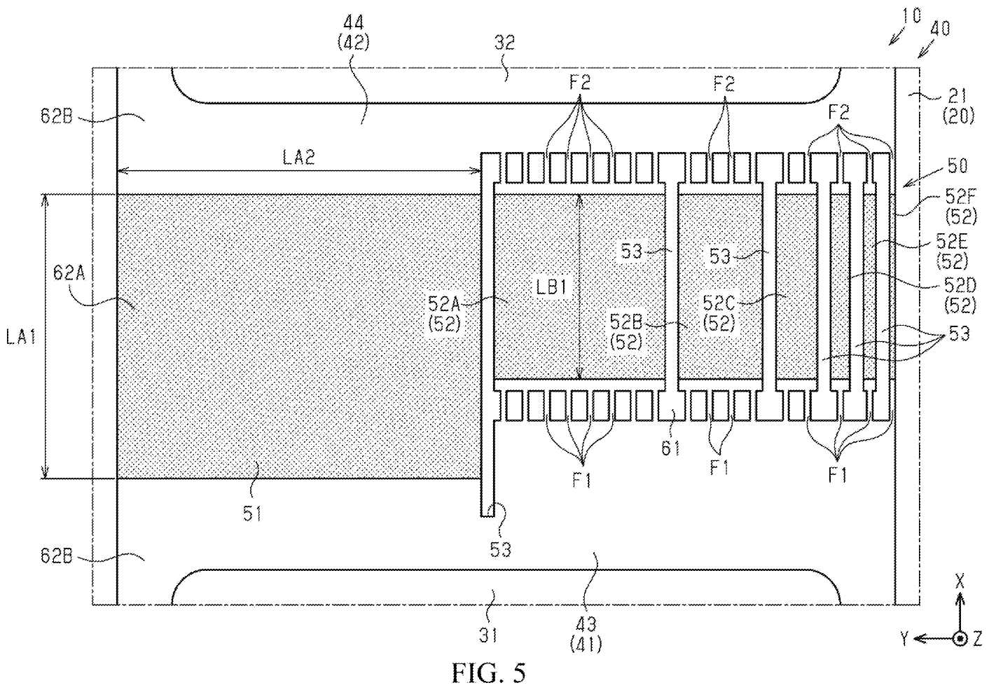

Referring to FIG. 5, the structure of the resistive element 50 is described in detail below. FIG. 5 shows an enlarged diagram of the resistive element 50 and its periphery in a planar structure of the electronic part 10 in FIG. 3.

As shown in FIG. 5, the resistive element 50 includes a main resistor unit 51 and a correction resistor unit 52 extending along the X direction and arranged along the Y direction in the plan view. In the description below, for the sake of brevity, the X direction in the main resistor unit 51 and the correction resistor unit 52 is referred to as “a length direction”, and the Y direction in the main resistor unit 51 and the correction resistor unit 52 is referred to as “a width direction”. Sometimes sizes of the main resistor unit 51 and the correction resistor unit 52 along the X direction are referred to as “a length of the main resistor unit 51” and “a length of the correction resistor unit 52”, and sizes of the main resistor unit 51 and the correction resistor unit 52 along the Y direction are referred to as “a width of the main resistor unit 51” and “a width of the correction resistor unit 52”.

In the example in FIG. 5, in the plan view, the main resistor unit 51 is formed to have a rectangular shape with the Y direction as a long-side direction and the X direction as a short-side direction. Thus, it can be said that the main resistor unit 51 is formed to have a width greater than a length thereof.

The correction resistor unit 52 includes a first correction resistor 52A, a second correction resistor 52B, a third correction resistor 52C, a fourth correction resistor 52D, a fifth correction resistor 52E and a sixth correction resistor 52F. The first to sixth correction resistors 52A to 52F are spaced apart from one another along the Y direction by a separator 53 separating the correction resistor unit 52 along the X direction.

The main resistor unit 51 and the first to sixth correction resistors 52A to 52F can be set such that, for example, resistance values of the main corrector 51, the first correction resistor 52A, the second correction resistor 52B, the third correction resistor 52C, the fourth correction resistor 52D, the fifth correction resistor 52E and the sixth correction resistor 52F increase in an order of a geometric sequence. In one example, it can be set such that, areas in the plan view decrease in an order of the main corrector 51, the first correction resistor 52A, the second correction resistor 52B, the third correction resistor 52C, the fourth correction resistor 52D, the fifth correction resistor 52E and the sixth correction resistor 52F.

In one example, the resistance value of the main resistor unit 51 is 40Ω (the initial term of the geometric sequence), and the resistance values of the first correction resistor 52A, the second correction resistor 52B, the third correction resistor 52C, the fourth correction resistor 52D, the fifth correction resistor 52E and the sixth correction resistor 52F can be set according to a geometric sequence with a common ratio of 2. More specifically, the resistance value of the first correction resistor 52A is 80Ω, the resistance value of the second correction resistor 52B is 160Ω, the resistance value of the third correction resistor 52C is 320Ω, the resistance value of the fourth correction resistor 52D is 640Ω, the resistance value of the fifth correction resistor 52E is 1280Ω, and the resistance value of the sixth correction resistor 52F is 2560Ω. Moreover, these resistance values are examples of the resistance values of the main resistor unit 51 and the first to sixth correction resistors 52A to 52F, and the resistance values of the resistance values of the main resistor unit 51 and the first to sixth correction resistors 52A to 52F can be appropriately modified according to the specifications of the electronic part 10.

In the example shown in FIG. 5, the main resistor unit 51 is electrically inseparably connected to the first wiring 41 and the second wiring 42. In one example, the main resistor unit 51 is connected to the first wiring 41 and the second wiring 42 throughout an entirety along the Y direction. That is to say, the main resistor unit 51 is connected to the first wiring 41 and the second wiring 42 without involving a first fuse F1 or a second fuse F2 described below. Thus, the main resistor unit 51 is constantly connected to the first wiring 41 and the second wiring 42. That is to say, the main resistor unit 51 is constantly electrically connected to the first external terminal 31 and the second external terminal 32. The main resistor unit 51 is arranged in regions sandwiching the first wiring 41 and the second wiring 42 along the X direction. Thus, regardless of whether the first fuse F1 and the second fuse F2 are blown, the first wiring 41 and the second wiring 42 can be constantly connected by a shortest distance.

In the example shown in FIG. 5, the correction resistor unit 52 is electrically separably connected to the first wiring 41 and the second wiring 42. That is to say, the first to sixth correction resistors 52A to 52F are electrically separably connected to the first wiring 41 and the second wiring 42 on two ends along the X direction.

In one example, the resistive circuit portion 40 includes a plurality of first fuses F1 connecting the correction resistor unit 52 and the first wiring 41 in a separable manner, and a plurality of second fuses F2 connecting the correction resistor unit 52 and the second wiring 42 in a separable manner. The plurality of first fuses F1 are disposed in a first connection region 43 connected with the resistive element 50 in the first wiring 41. The plurality of second fuses F2 are disposed in a second connection region 44 connected with the resistive element 50 in the second wiring 42. Each of the first fuses F1 and the second fuses F2 is formed by the first conductive film 62B and the resistive film 62A. Each of the first fuses F1 and the second fuses F2 is formed as a thin strip extending along the X direction in the plan view.

The first connection region 43 is a region between the first external terminal 31 and the resistive element 50 along the X direction in the first wiring 41 in the plan view. The first connection region 43 is formed, for example, throughout an entirety along the Y direction of the resistive element 50. In the example shown in FIG. 5, the plurality of first fuses F1 are formed in a region adjacent to the first to sixth correction resistors 52A to 52F along the X direction in the first connection region 43.

The second connection region 44 is a region between the second external terminal 32 and the resistive element 50 along the X direction in the second wiring 42 in the plan view. The second connection region 44 is formed, for example, throughout an entirety along the Y direction of the resistive element 50. In the example shown in FIG. 5, the plurality of second fuses F2 are formed in a region adjacent to the first to sixth correction resistors 52A to 52F along the X direction in the second connection region 44.

The plurality of first fuses F1 connect each of the first to sixth correction resistors 52A to 52F and the first wiring 41 in a separable manner. The plurality of second fuses F2 connect each of the first to sixth correction resistors 52A to 52F and the second wiring 42 in a separable manner. The plurality of first fuses F1 are parts that connect the first to sixth correction resistors 52A to 52F and the first wiring 41. The plurality of first fuses F1 are spaced from each other along the Y direction. In other words, in a part between adjacent first fuses F1 along the Y direction, the first conductive film 62B and the resistive film 62A are removed, and the substrate insulating layer 61 is exposed. The plurality of second fuses F2 are parts that connect the first to sixth correction resistors 52A to 52F and the second wiring 42. The plurality of second fuses F2 are spaced from each other along the Y direction. In other words, in a part between adjacent second fuses F2 along the Y direction, the first conductive film 62B and the resistive film 62A are removed, and the substrate insulating layer 61 is exposed. In one example, the number of the plurality of first fuses F1 is equal to the number of the plurality of second fuses F2.

The numbers of the first fuses F1 and the second fuses F2 are set according to the widths of the first to sixth correction resistors 52A to 52F. That is to say, the numbers of the first fuses F1 and the second fuses F2 are the greatest in the first correction resistor 52A and are least in the fourth to sixth correction resistors 52D to 52F. In one example, the respective numbers of the first fuses F1 and the second fuses F2 corresponding to the first correction resistor 52A are 8, the respective numbers of the first fuses F1 and the second fuses F2 corresponding to the second correction resistor 52B are 4, the respective numbers of the first fuses F1 and the second fuses F2 corresponding to the third correction resistor 52C are 2, and the respective numbers of the first fuses F1 and the second fuses F2 corresponding to the each of the fourth to sixth correction resistors 52D to 52F are 1.

### [Method for Adjusting Resistance Value of Resistive Circuit Portion]

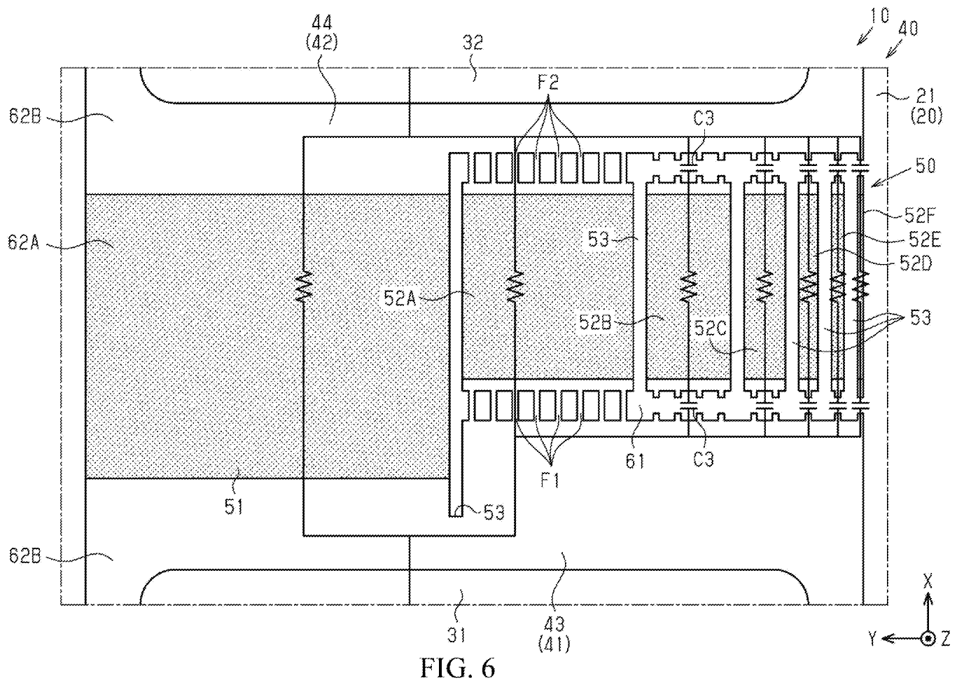

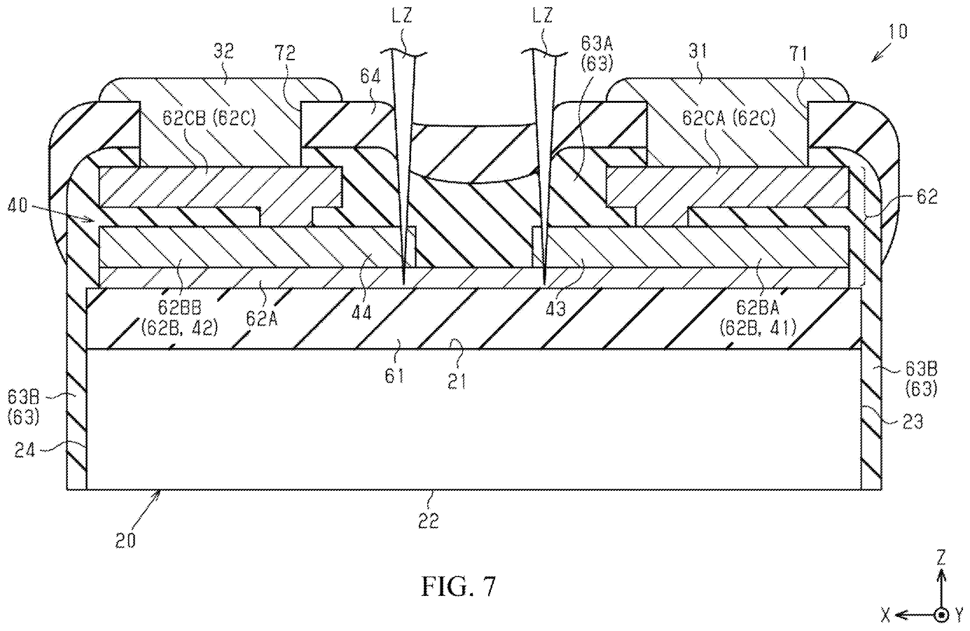

Referring to FIG. 6 to FIG. 7, an example of a method for adjusting the resistance value of the resistive circuit portion 40 is described below.

FIG. 6 shows an enlarged diagram of a planar structure of the resistive element 50 and its periphery when the first and second fuses F1 and F2 in FIG. 5 are blown. FIG. 7 shows a brief cross-sectional diagram of the structure of the electronic part 10 in a step of blowing the fuses F1 and F2. Moreover, FIG. 7 shows a cross-sectional structure of a same part of the cross-sectional structure of the electronic part 10 shown in FIG. 5.

As shown in FIG. 7, in the electronic part 10, the first fuse F1 and the second fuse F2 are blown by a laser LZ, and the overall resistance value of the resistive circuit portion 40 is set to any desired resistance value.

In one example, as shown in FIG. 6, all of the first fuses F1 and the second fuses F2 connected to the second to sixth correction resistors 52B to 52F are blown, and the second to sixth correction resistors 52B to 52F are electrically separated from the resistive circuit portion 40. On the other hand, none of the plurality of first fuses F1 and the plurality of second fuses F2 connected to the first correction resistor 52A is blown. Accordingly, in the resistive circuit portion 40, a circuit connected in parallel with the main resistor unit 51 and the first correction resistor 52A is formed between the first wiring 41 and the second wiring 42.

### [Circuit Configuration of First Resistive Circuit Portion]

Referring to FIG. 6 to FIG. 8, a circuit configuration of the resistive circuit portion 40 related to the resistive element 50 is described below. FIG. 6 shows an example of an equivalent circuit of the resistive circuit portion 40.

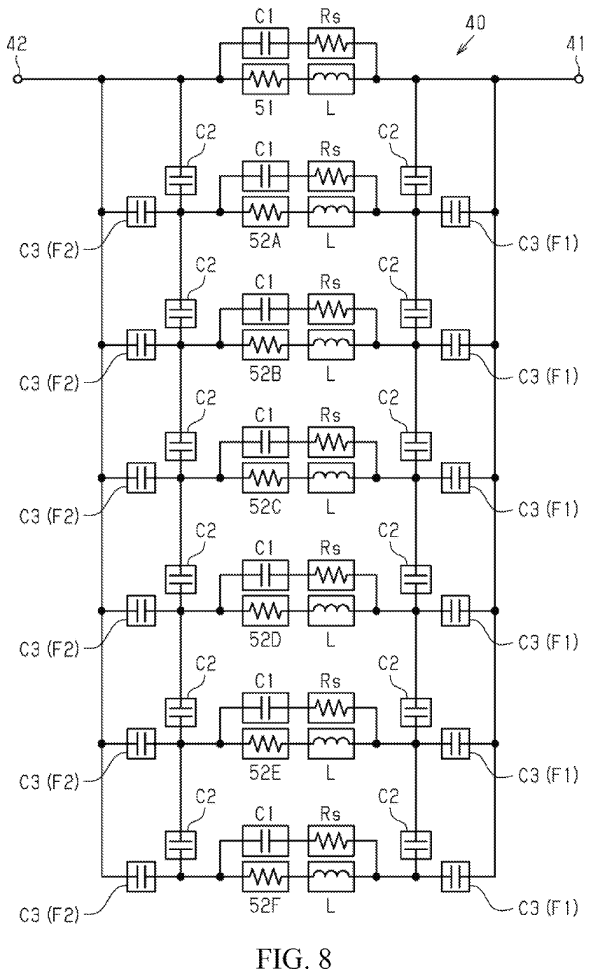

As shown in FIG. 8, the resistive circuit portion 40 is provided with the main resistor unit 51 and the first to sixth correction resistors 52A to 52F of the correction resistor unit 52 connected in parallel on a conductive path from the first wiring 41 to the second wiring 42. A first terminal of each of the first to sixth correction resistors 52A to 52F close to the first wiring 41 is electrically connected with the first wiring 41 via the first fuse F1. A second terminal of each of the first to sixth correction resistors 52A to 52F close to the second wiring 42 is electrically connected with the second wiring 42 via the second fuse F2.

Each of the main resistor unit 51 and the first to sixth correction resistors 52A to 52F is connected in series with a parasitic inductor L, and is connected in parallel with a serial circuit of a capacitor C1 and a resistor Rs.

The parasitic inductor L includes a parasitic inductor dependent on the widths and the lengths of the main resistor unit 51 and the first to sixth correction resistors 52A to 52F. That is to say, the parasitic inductor L can be adjusted by adjusting at least one of the widths and the lengths of the main resistor unit 51 and the first to sixth correction resistors 52A to 52F. In one example, the parasitic inductor L is reduced by reducing the lengths of the first to sixth correction resistors 52A to 52F. In one example, the parasitic inductor L is reduced by increasing the widths of the first to sixth correction resistors 52A to 52F.

The resistor Rs includes a resistance of the substrate 20. The capacitor C1 connected in series with the resistor Rs includes, for example, a parasitic capacitance generated between the resistive film 62A and the substrate 20 by a substrate insulating film (the substrate insulating layer 61 in the first embodiment) of the resistive film 62A, and a parasitic capacitance generated between the resistive film 62A and the second conductive film 62C by the surface insulating layer 63. A capacitor C2 includes, for example, a parasitic capacitance generated between the main resistor unit 51 and the first to sixth correction resistors 52A to 52F by a substrate insulating film (the substrate insulating layer 61 in the first embodiment) of the resistive film 62A and the surface insulating layer 63. A capacitor C3 includes a parasitic capacitance generated by blowing of the first fuses F1 and the second fuses F2 corresponding to the first to sixth correction resistors 52A to 52F.

As shown in FIG. 6, when all of the first fuses F1 and all of the second fuses F2 corresponding to the second correction resistor 52B are blown, the capacitor C3 is formed on both sides of the second correction resistor 52B along the X direction. The reasons of the above is that, the second correction resistor 52B and the first wiring 41 and the second wiring 42 are arranged to face each other across a space produced by blowing all of the first fuses F1 and all of the second fuses F2 corresponding to the second correction resistor 52B. The same applies to the third to sixth correction resistors 52C to 52F. That is, the capacitors C3 are formed on both sides of each of the third to sixth correction resistors 52C to 52F by blowing the first fuses F1 and the second fuses F2. Moreover, when the first fuses F1 and the second fuses F2 of the first correction resistor 52A are blown, similar to the second to sixth correction resistors 52B to 52F, the capacitors C3 are formed on both sides of the first correction resistor 52A along the X direction. Characteristics of an impedance of the resistive circuit portion 40 with respect to a frequency are determined based on the capacitors C1 to C3, the resistor Rs and the parasitic inductor L described above.

### [Structure for Adjusting Impedance in High-Frequency Bandwidth]

Referring to FIG. 5, a structure for adjusting an impedance of the resistive circuit portion 40 in a high-frequency bandwidth is described below. Herein, a high-frequency bandwidth is, for example, a bandwidth in tens of GHz, and is 10 GHz to 40 GHz in one example.

As shown in FIG. 5, an impedance value of the resistive circuit portion 40 in a high-frequency bandwidth is adjusted based on the configuration of the resistive element 50. The impedance value of the resistive circuit portion 40 in a high-frequency bandwidth is adjusted such that an impedance value at a specified high frequency in a circuit from the first wiring 41 to the second wiring 42 is consistent with or close to a predetermined impedance value. In addition, a method for adjusting an impedance value in a high-frequency bandwidth is primarily, for example, adjusting the length of the correction resistor unit 52 and adjusting an arrangement order of the first to sixth correction resistors 52A to 52F.

In the adjustment of a length LB1 of the correction resistor unit 52, the length LB1 of the correction resistor unit 52 is less than a length LA1 of the main resistor unit 51. More specifically, the lengths of the first to sixth correction resistors 52A to 52F are equal to one another. Thus, the lengths of the first to sixth correction resistors 52A to 52F can be set to be “the length LB1”. The length LB1 of the first to sixth correction resistors 52A to 52F is less than the length LA1 of the main resistor unit 51. Thus, it can be said that the length LB1 of the correction resistor unit 52 is less than the length LA1 of the main resistor unit 51. In one example, the length LB1 of the correction resistor unit 52 is between about ½ and about ¾ of the length LA1 of the main resistor unit 51. In the first embodiment, the length LB1 of the correction resistor unit 52 is ¾ of the length LA1 of the main resistor unit 51. Herein, in the first embodiment, the main resistor unit 51 is an example of “a first resistor unit”, and the correction resistor unit 52 is an example of “a second resistor unit”.

The main resistor unit 51 is formed to have a rectangular shape with the X direction as a short-side direction and the Y direction as a long-side direction in the plan view. That is to say, the length LA1 of the main resistor unit 51 is less than a width LA2 (a size of the main resistor unit 51 along the Y direction) of the main resistor unit 51. Each of the first to sixth correction resistors 52A to 52F is formed to have a rectangular shape with the X direction as a long-side direction and the Y direction as a short-side direction in the plan view.

The first to sixth correction resistors 52A to 52F are arranged sequentially from the side close to the main resistor unit 51 along the Y direction. That is to say, the first correction resistor 52A is arranged at a position closest to the main resistor unit 51 along the Y direction, and the sixth correction resistor 52F is arranged at a position farthest away from the main resistor unit 51 along the Y direction.

The widths of the first to sixth correction resistors 52A to 52F are different from one another. In one example, the width of the first correction resistor 52A is more than the widths of the second to sixth correction resistors 52B to 52F and the width of the sixth correction resistor 52F is less than the widths of the first to fifth correction resistors 52A to 52E. That is to say, the width of the first correction resistor 52A is the largest, and the width of the sixth correction resistor 52F is the smallest. Moreover, in the first embodiment, the width gradually decreases from the first correction resistor 52A toward the sixth correction resistor 52F. More specifically, the width of the second correction resistor 52B is less than the width of the first correction resistor 52A, and the width of the third correction resistor 52C is less than the width of the second correction resistor 52B. Moreover, the width of the fourth correction resistor 52D is less than the width of the third correction resistor 52C, the width of the fifth correction resistor 52E is less than the width of the fourth correction resistor 52D, and the width of the sixth correction resistor 52F is less than the width of the fifth correction resistor 52E.

In other words, in the first embodiment, in the plan view, the area gradually decreases from the first correction resistor 52A toward the sixth correction resistor 52F. More specifically, the area of the second correction resistor 52B is less than the area of the first correction resistor 52A, and the area of the third correction resistor 52C is less than the area of the second correction resistor 52B. Moreover, the area of the fourth correction resistor 52D is less than the area of the third correction resistor 52C, the area of the fifth correction resistor 52E is less than the area of the fourth correction resistor 52D, and the area of the sixth correction resistor 52F is less than the area of the fifth correction resistor 52E.

In one example, the width of each of the first to sixth correction resistors 52A to 52F is less than the width LA2 of the main resistor unit 51. Moreover, a total width of the first to sixth correction resistors 52A to 52F is less than the width LA2 of the main resistor unit 51. Accordingly, the area of each of the first to sixth correction resistors 52A to 52F is less than the area of the main resistor unit 51. A total area of the first to sixth correction resistors 52A to 52F is less than the area of the main resistor unit 51.

### [Effects]

The electronic part 10 according to the first embodiment achieves the following effects.

(1-1) The electronic part 10 includes: the substrate 20, having the first main surface 21; the first external terminal 31 and the second external terminal 32, formed on the first main surface 21 and spaced apart from each other; and the resistive circuit portion 40, formed on the first main surface 21 and electrically connected to the first external terminal 31 and the second external terminal 32. The resistive circuit portion 40 includes: the first wiring 41, formed on the first main surface 21 and to which the first external terminal 31 is electrically connected; the second wiring 42, formed on the first main surface 21 and electrically connected to the second external terminal 32; a first resistor unit which is the main resistor unit 51 and a second resistor unit which is the correction resistor unit 52 that are electrically connected to the first wiring 41 and the second wiring 42 and extend along the X direction in a plan view and are arranged along the Y direction. The length LB1 of the correction resistor unit 52 is less than the length LA1 of the main resistor unit 51.

According to the configuration above, by configuring the length LB1 of the correction resistor unit 52 to be less than the length LA1 of the main resistor unit 51, a variation range of an impedance of the resistive circuit portion 40 in a high-frequency bandwidth can be reduced. Thus, impedance characteristics of the resistive circuit portion 40 in a high-frequency bandwidth can be enhanced. Moreover, by configuring the length LA1 of the main resistor unit 51 to be more than the length LB1 of the correction resistor unit 52, a decrease in the damage resistance of the main resistor unit 51 can be suppressed.

(1-2) The length LB1 of the correction resistor unit 52 is between about ½ and about ¾ of the length LA1 of the main resistor unit 51.

According to the configuration above, a variation range of an impedance of the resistive circuit portion 40 in a high-frequency bandwidth can be reduced. Thus, impedance characteristics of the resistive circuit portion 40 in a high-frequency bandwidth can be enhanced.

(1-3) The main resistor unit 51 is electrically inseparably connected to the first wiring 41 and the second wiring 42. The correction resistor unit 52 is electrically separably connected to the first wiring 41 and the second wiring 42.

According to the configuration above, by electrically separating the correction resistor unit 52, the resistance value of the resistive circuit portion 40 can be adjusted. Thus, the resistance value of the resistive circuit portion 40 can be made consistent with a required resistance value.

(1-4) The correction resistor unit 52 includes a first correction resistor 52A, a second correction resistor 52B and a third correction resistor 52C adjacent to one another along the Y direction. The first correction resistor 52A, the second correction resistor 52B and the third correction resistor 52C are arranged in an order above and toward a side away from the main resistor unit 51 along the Y direction. The width of the second correction resistor 52B (the size along the Y direction) is less than the width of the first correction resistor 52A (the size along the Y direction). The width of the third correction resistor 52C (the size along the Y direction) is less than the width of the second correction resistor 52B (the size along the Y direction).

According to the configuration above, by arranging the first correction resistor 52A, the second correction resistor 52B and the third correction resistor 52C in a decreasing order of widths and toward a side away from the main resistor unit 51, a variation range of an impedance of the resistive circuit portion 40 in a high-frequency bandwidth can be reduced. Thus, impedance characteristics of the resistive circuit portion 40 in a high-frequency bandwidth can be enhanced.

(1-5) The resistive circuit portion 40 includes:
the first fuse F1, connecting the correction resistor unit 52 and the first wiring 41 in a separable manner; and the second fuse F2, connecting the correction resistor unit 52 and the second wiring 42 in a separable manner.

According to the configuration above, the first fuse F1 and the second fuse F2 are distributed on both sides of the correction resistor unit 52 along the X direction. The correction resistor unit 52 includes the first to sixth correction resistors 52A to 52F connected in parallel by the first fuse F1 and the second fuse F2. For example, when the first fuse F1 and the second fuse F2 corresponding to one correction resistor unit are blown, a parasitic capacitance CP generated by the correction resistor unit 52 is equivalent to a state in which two capacitors C3 connected in series are generated between the first wiring 41 and the second wiring 42 and the one correction resistor unit of the resistive circuit portion 40 due to blowing of the fuses F1 and F2. Thus, the parasitic capacitance CP uses the same denotation, and a capacitance value thereof is set to CP=C3/2 based on an equation of 1/CP=1/C3+1/C3. On the other hand, when only one of the first fuse F1 and the second fuse F2 is flown, the parasitic capacitance CP generated by the correction resistor unit 52 is based on one capacitor C3 generated in the resistive circuit portion 40. Thus, the parasitic capacitor CP is equivalent to one capacitor C3 (CP=C3). That is to say, by blowing both of the first fuse F1 and the second fuse F2, the parasitic capacitance CP generated by the correction resistor unit 52 can be reduced by a half. The first to sixth correction resistors 52A to 52F are connected in parallel with one another. Thus, it can be said that the same applies to a situation where the first fuses F1 and the second fuses F2 corresponding to a plurality of correction resistors are blown. As a result, an impedance of the resistive circuit portion 40 can be increased.

### Second Embodiment

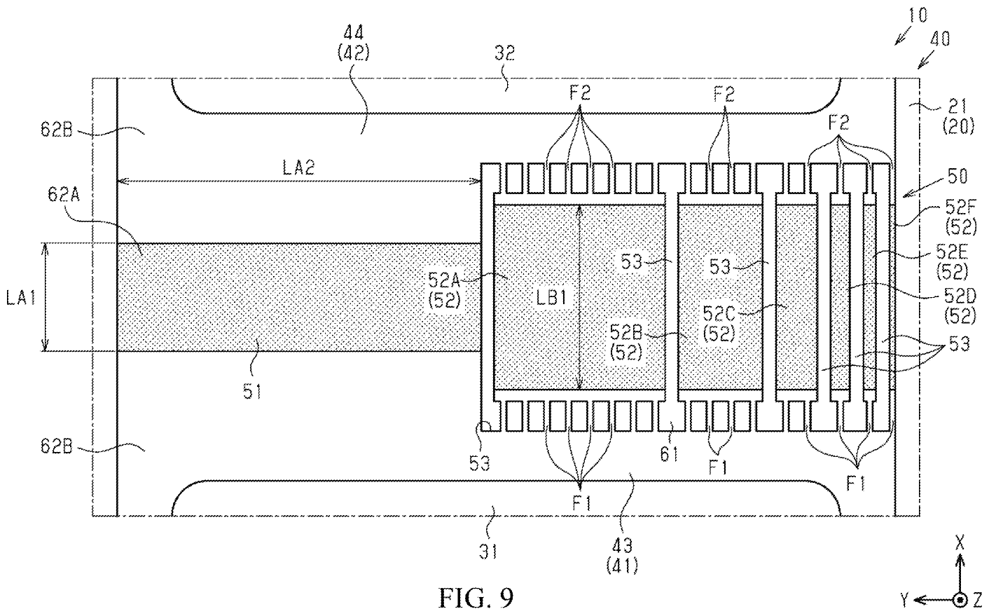

Referring to FIG. 9, the electronic part 10 of the second embodiment is described below. The electronic part 10 of the second embodiment primarily differs from the electronic part 10 of the first embodiment in respect of the configuration of the resistive element 50. In the description below, items different from those of the electronic part 10 of the first embodiment are described in detail, and constituting elements in common with those of the electronic part 10 of the first embodiment are represented by the same denotations and associated details thereof are omitted for brevity.

As shown in FIG. 9, in the second embodiment, the length LA1 of the main resistor unit 51 is less than the length LB1 of the correction resistor unit 52. In one example, the length LA1 of the main resistor unit 51 is ½ of the length LB1 of the correction resistor unit 52. Thus, in the second embodiment, the main resistor unit 51 is an example of “a second resistor unit”, and the correction resistor unit 52 is an example of “a first resistor unit”.

In the example shown in FIG. 9, the length LA1 of the main resistor unit 51 is less than ½ of the width (the size along the Y direction) of the main resistor unit 51. In one example, the length LA1 of the main resistor unit 51 can also be less than ⅓ of the width of the main resistor unit 51. In one example, the length LA1 of the main resistor unit 51 can also be more than ⅓ of the width of the main resistor unit 51. Moreover, in the second embodiment, the length LA1 of the main resistor unit 51 can be modified as desired within a range of less than the length LB1 of the correction resistor unit 52.

The main resistor unit 51 is arranged at a position same as a center of the correction resistor unit 52 along the X direction. Moreover, since the width of the main resistor unit 51, and the configuration and width of the correction resistor unit 52 are the same as those of the first embodiment, associated details are omitted herein. In addition, the position of the main resistor unit 51 with respect to the correction resistor unit 52 along the X direction can be modified as desired.

### [Effects]

The electronic part 10 according to the second embodiment achieves the following effects.

(2-1) The length LA1 of the main resistor unit 51 is less than the length LB1 of the correction resistor unit 52.

According to the configuration above, a variation range of an impedance of the resistive circuit portion 40 in a high-frequency bandwidth can be reduced. Thus, impedance characteristics of the resistive circuit portion 40 in a high-frequency bandwidth can be enhanced.

### Third Embodiment

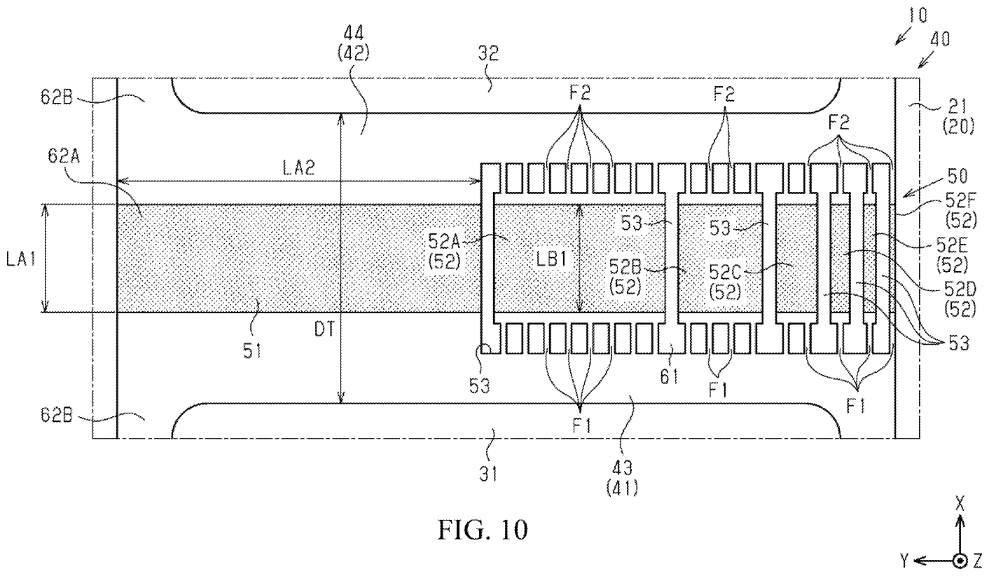

Referring to FIG. 10, the electronic part 10 of the third embodiment is described below. The electronic part 10 of the third embodiment primarily differs from the electronic part 10 of the second embodiment in respect of the configuration of the resistive element 50. In the description below, items different from those of the electronic part 10 of the second embodiment are described in detail, and constituting elements in common with those of the electronic part 10 of the second embodiment are represented by the same denotations and associated details thereof are omitted for brevity.

As shown in FIG. 10, in the third embodiment, the length LB1 of the correction resistor unit 52 is less than the length LB1 of the correction resistor unit 52 of the second embodiment (referring to FIG. 5). In the third embodiment, the length LB1 of the correction resistor unit 52 is equal to the length LA1 of the main resistor unit 51. The length LA1 of the main resistor unit 51 of the third embodiment is equal to the length LA1 of the main resistor unit 51 of the second embodiment (referring to FIG. 9). In one example, the length LA1 of the main resistor unit 51 is between about ¼ and about ½ of the width LA2 of the main resistor unit 51.

In the example shown in FIG. 10, the length LB1 of the first correction resistor 52A of the correction resistor unit 52 is less than the width (the size along the Y direction) of the first correction resistor 52A. In addition, in the example shown in FIG. 10, both of the length LA1 of the main resistor unit 51 and the length LB1 of the correction resistor unit 52 can be, for example, less than ½ of a distance DT between the first external terminal 31 and the second external terminal 32 along the X direction. As such, both of the length LA1 of the main resistor unit 51 and the length LB1 of the correction resistor unit 52 can be reduced, hence adjusting an impedance of the resistive circuit portion 40 in a high-frequency bandwidth.

### Fourth Embodiment

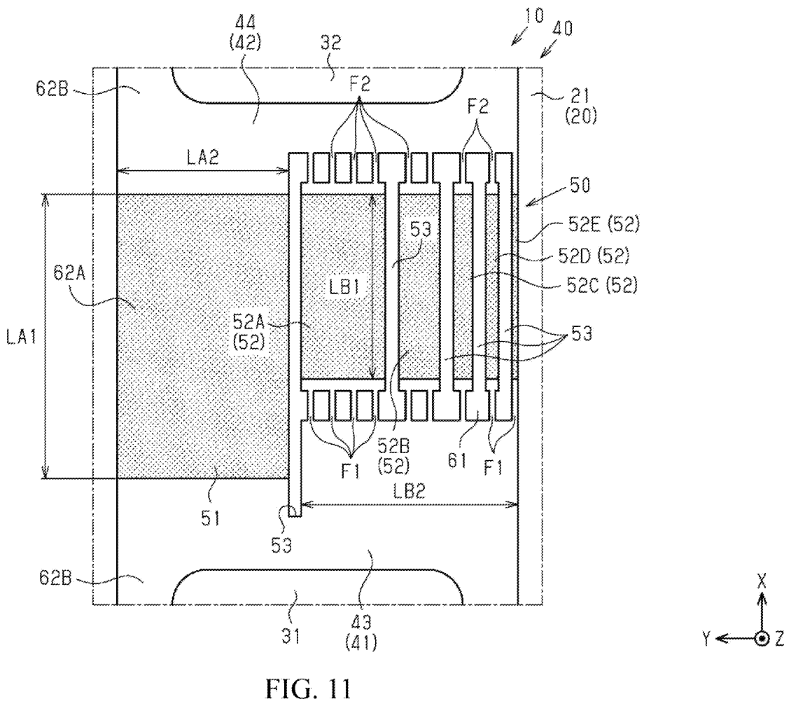

Referring to FIG. 11, the electronic part 10 of the fourth embodiment is described below. The electronic part 10 of the fourth embodiment primarily differs from the electronic part 10 of the first embodiment in respect of the configuration of the resistive element 50. In the description below, items different from those of the electronic part 10 of the first embodiment are described in detail, and constituting elements in common with those of the electronic part 10 of the first embodiment are represented by the same denotations and associated details thereof are omitted for brevity.

As shown in FIG. 11, in the fourth embodiment, the width LA2 of the main resistor unit 51 is less than the width LA2 of the main resistor unit 51 of the first embodiment (referring to FIG. 5). The width of the correction resistor unit 52 is less than the width of the correction resistor unit 52 of the first embodiment. In one example, the length LA1 of the main resistor unit 51 is more than the width LA2 of the main resistor unit 51. In one example, the length LB1 of the correction resistor unit 52 is less than the width LB2 of the correction resistor unit 52. In one example, the length LA1 of the main resistor unit 51 is more than the length LB1 of the correction resistor unit 52. Thus, in the fourth embodiment, the main resistor unit 51 is an example of “a first resistor unit”, and the correction resistor unit 52 is an example of “a second resistor unit”.

In the fourth embodiment, the correction resistor unit 52 includes the first to fifth correction resistors 52A to 52E. That is to say, the number of correction resistors of the correction resistor unit 52 of the fourth embodiment is less than the number of correction resistors of the correction resistor unit 52 of the first embodiment.

As such, by modifying the respective widths of the main resistor unit 51 and the correction resistor unit 52, an impedance of the resistive circuit portion 40 can be adjusted. More specifically, by reducing the respective widths of the main resistor unit 51 and the correction resistor unit 52, an impedance of the resistive circuit portion 40 in a high-frequency bandwidth can be increased.

### [Effects]

The electronic part 10 according to the fourth embodiment achieves the following effects.

(4-1) The length LA1 of the main resistor unit 51 is more than the width LA2 of the main resistor unit 51. The length LB1 of the correction resistor unit 52 is more than the width LB2 of the correction resistor unit 52. According to the configuration above, the width of the resistive element 50 can be reduced. Thus, miniaturization of the electronic part 10 along the Y direction can be achieved.

### Fifth Embodiment

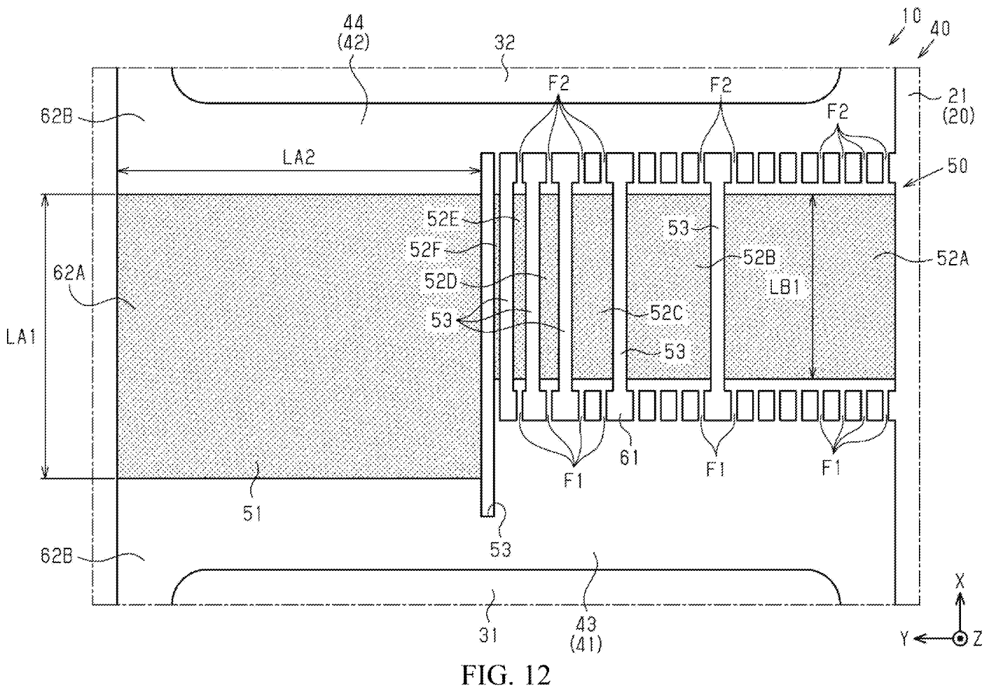

Referring to FIG. 12, the electronic part 10 of the fifth embodiment is described below. The electronic part 10 of the fifth embodiment primarily differs from the electronic part 10 of the first embodiment in respect of the configuration of the resistive element 50. In the description below, items different from those of the electronic part 10 of the first embodiment are described in detail, and constituting elements in common with those of the electronic part 10 of the first embodiment are represented by the same denotations and associated details thereof are omitted for brevity.

As shown in FIG. 12, in the correction resistor unit 52, the sixth correction resistor 52F, the fifth correction resistor 52E, the fourth correction resistor 52D, the third correction resistor 52C, the second correction resistor 52B and the first correction resistor 52A are sequentially arranged toward a side away from the main resistor unit 51 along the Y direction. That is to say, the correction resistor unit 52 is configured such that widths of the correction resistors decrease as getting closer to the main resistor unit 51.

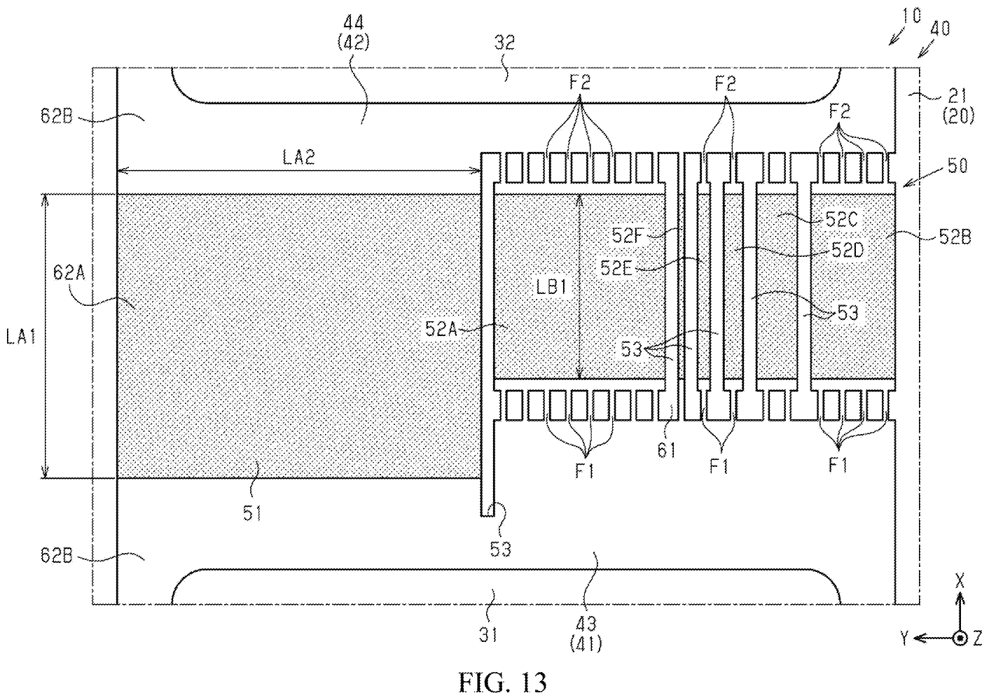

Moreover, as shown in FIG. 13, in the correction resistor unit 52, the sixth correction resistor 52F, the fifth correction resistor 52E, the fourth correction resistor 52D, the third correction resistor 52C and the second correction resistor 52B can also be sequentially arranged toward a side away from the first correction resistor 52A along the Y direction. The first correction resistor 52A is adjacent to the main resistor unit 51 in the Y direction. As such, by modifying the configurations of the first to sixth correction resistors 52A to 52F, an impedance of the resistive circuit portion 40 in a high-frequency bandwidth is adjusted.

In the examples shown in FIG. 12 and FIG. 13, the length LB1 of the correction resistor unit 52 is less than the length LA1 of the main resistor unit 51. Thus, in the fifth embodiment, the main resistor unit 51 is an example of “a first resistor unit”, and the correction resistor unit 52 is an example of “a second resistor unit”.

### Variation Examples

The embodiments can be modified and be accordingly implemented as below. Given that no technical contradiction is resulted, the following variation examples can be used in combination.
Given that no technical contradiction is resulted, the first to fifth embodiments can be used in combination.

In one example, in the fourth embodiment, a relationship between the length LA1 of the main resistor unit 51 and the length LB1 of the correction resistor unit 52 can be modified as desired. In one example, the length LA1 of the main resistor unit 51 can also be less than the length LB1 of the correction resistor unit 52. In one example, the length LA1 of the main resistor unit 51 can also be equal to the length LB1 of the correction resistor unit 52.

In one example, in the fifth embodiment, a relationship between the length LA1 of the main resistor unit 51 and the length LB1 of the correction resistor unit 52 can be modified as desired. In one example, the length LA1 of the main resistor unit 51 can also be less than the length LB1 of the correction resistor unit 52. In one example, the length LA1 of the main resistor unit 51 can also be equal to the length LB1 of the correction resistor unit 52.
In the embodiments, the second conductive film 62C can also be omitted from the element stack portion 62.
In the embodiments, the number of the correction resistor unit 52 can be modified as desired.
In the embodiments, either the first fuse F1 or the second fuse F2 can be omitted.
In the embodiments, an example of applying the electronic part 10 to a chip resistor is given as an example; however, instead of a chip resistor, the electronic part 10 can also be applied to an electronic part using the resistive circuit portion 40.

In the present disclosure, the expression “at least one of A and B” should be understood as “only A, or only B, or both of A and B”.

One or more examples recited herein can be combined within scopes that are not technically contradictory.

The terms “first”, “second” and “third” of the present disclosure are for distinguishing target objects, and are not intended for sorting the target objects.

The terms such as “on” used in the present disclosure also includes meanings of “over” and “above”, unless otherwise specified in the context. Thus, the expression “a first element arranged on a second element” can refer to that the first element directly disposed on the second element by contacting the second element in some embodiments, or can refer to that the first element is disposed over or above the second element without contacting the second element in other embodiments. That is to say, the expression “on/over/above” does not eliminate a structure forming other element between the first element and the second element.

The Z direction used in the present disclosure is not necessarily a vertical direction, and is not necessarily completely consistent with the vertical direction. Thus, various structures associated with the present disclosure do not limit “up/top” and “down/bottom” in the Z direction described herein to be “up” and “down” in the vertical direction. For example, the X direction can be the vertical direction, or the Y direction can be the vertical direction.

### <Note>

The technical ideas that can be understood from this disclosure are described below. Note that, not for the purpose of limitation but for the purpose of aiding understanding, the reference numerals of the corresponding components in the above embodiment are attached to the components described in the supplementary notes. Reference numerals are shown by way of example to aid understanding, and the components described in each appendix should not be limited to the components indicated by the reference numerals.

### [Note 1]

An electronic part (10), comprising:
a substrate (20), having a first main surface (21);
a first external terminal (31) and a second external terminal (32), formed on the first main surface (21) and spaced apart from each other; and
a resistive circuit portion (40), formed on the first main surface (21) and electrically connected to the first external terminal (31) and the second external terminal (32),
wherein the resistive circuit portion (40) includes:
   a first wiring (41), formed on the first main surface (21) and to which the first external terminal (31) is electrically connected;
   a second wiring (42), formed on the first main surface (21) and electrically connected to the second external terminal (32); and
   a first resistor unit (51) and a second resistor unit (52) that are electrically connected to the first wiring (41) and the second wiring (42), extend along a first direction (X direction) in a plan view and are arranged along a second direction (Y direction) orthogonal to the first direction (X direction),
wherein a length (LB1) of the second resistor unit (52) along the first direction (X direction) is less than a length (LA1) of the first resistor unit (51) along the first direction (X direction).

### [Note 2]

The electronic part of Note 1, wherein the length (LB1) of the second resistor unit (52) along the first direction (X direction) is between about ½ and about ¾ of the length (LA1) of the first resistor unit (51) along the first direction (X direction).

### [Note 3]

The electronic part of Note 1 or 2, wherein
the first resistor unit is a main resistor unit (51) that is electrically inseparably connected to the first wiring (41) and the second wiring (42), and
the second resistor unit is a correction resistor unit (52) that is electrically separably connected to the first wiring (41) and the second wiring (42).

### [Note 4]

The electronic part of Note 1 or 2, wherein
the first resistor unit is a correction resistor unit (52) that is electrically separably connected to the first wiring (41) and the second wiring (42), and
the second resistor unit is a main resistor unit (51) that is electrically inseparably connected to the first wiring (41) and the second wiring (42).

### [Note 5]

The electronic part of Note 3 or 4, wherein
the correction resistor unit (52) includes a first correction resistor (52A), a second correction resistor (52B) and a third correction resistor (52C) that are adjacent to each other along the second direction (Y direction),
the first correction resistor (52A), the second correction resistor (52B) and the third correction resistor (52C) are arranged in such order and toward a side away from the first resistor unit (51) along the second direction (Y direction),
a width of the second correction resistor (52B) along the second direction (Y direction) is less than a width of the first correction resistor (52A) along the second direction (Y direction), and
a width of the third correction resistor (52C) along the second direction (Y direction) is less than the width of the second correction resistor (52B) along the second direction (Y direction).

### [Note 6]

The electronic part of Note 5, wherein
a width (LA2) of the main resistor unit (51) along the second direction (Y direction) is greater than
the width of the first correction resistor (52A) along the second direction (Y direction),
the width of the second correction resistor (52B) along the second direction (Y direction), and
the width of the third correction resistor (52C) along the second direction (Y direction).

### [Note 7]

The electronic part of any one of Notes 3 to 6, wherein a width (LA2) of the main resistor unit (51) along the second direction (Y direction) is greater than a length (LA1) of the main resistor unit (51) along the first direction (X direction).

### [Note 8]

The electronic part of any one of Notes 3 to 7, wherein the resistive circuit portion (40) includes:
a first fuse (F1), connecting the correction resistor unit (52) and the first wiring (41) in a separable manner; and
a second fuse (F2), connecting the correction resistor unit (52) and the second wiring (42) in a separable manner.

### [Note 9]

The electronic part of any one of Notes 1 to 8, comprising an element stack portion (62), including a resistive film (62A) formed on the first main surface (21) and a first conductive film (62B) formed on the resistive film (62A), wherein
the first conductive film (62B) includes the first wiring (41) and the second wiring (42) physically separated from the first wiring (41), and
the first resistor unit (51) and the second resistor unit (52) are formed by a portion of the resistive film (62A) exposed from the first conductive film (62B) in a region between the first wiring (41) and the second wiring (42).

### [Note 10]

The electronic part of any one of Notes 1 to 9, wherein the electronic part (10) is a chip resistor.

### [Note 11]

An electronic part (10), comprising:
a substrate (20), having a first main surface (21);
a first external terminal (31) and a second external terminal (32), formed on the first main surface (21) and spaced apart from each other; and
a resistive circuit portion (40), formed on the first main surface (21) and electrically connected to the first external terminal (31) and the second external terminal (32),
wherein the resistive circuit portion (40) includes:
   a first wiring (41), formed on the first main surface (21) and to which the first external terminal (31) is electrically connected;
   a second wiring (42), formed on the first main surface (21) and electrically connected to the second external terminal (32); and
   a first resistor unit (51) and a second resistor unit (52) that are electrically connected to the first wiring (41) and the second wiring (42), extend along a first direction (X direction) in a plan view and are arranged along a second direction (Y direction) orthogonal to the first direction (X direction),
wherein both a length (LA1) of the first resistor unit (51) along the first direction (X direction) and a length (LB1) of the second resistor unit (52) along the first direction (X direction) are ½ or less of a distance between the first external terminal (31) and the second external terminal (32) along the first direction (X direction).

### [Note 12]

The electronic part of any one of Notes 3 to 6, wherein the length (LA1) of the main resistor unit (51) along the first direction (X direction) is greater than the width (LA2) of the main resistor unit (51) along the second direction (Y direction).

### [Note 13]

The electronic part of Note 3 or 4, wherein
the correction resistor unit (52) includes a first correction resistor (52A), a second correction resistor (52B) and a third correction resistor (52C) that are adjacent to each other along the second direction (Y direction),
a width of the second correction resistor (52B) along the second direction (Y direction) is less than a width of the first correction resistor (52A) along the second direction (Y direction),
a width of the third correction resistor (52C) along the second direction (Y direction) is less than the width of the second correction resistor (52B) along the second direction (Y direction), and
the third correction resistor (52C), the second correction resistor (52B) and the first correction resistor (52A) are arranged in such order and toward a side away from the main resistor unit (51) along the second direction (Y direction).

### [Note 14]

The electronic part of Note 3 or 4, wherein
the correction resistor unit (52) includes a first correction resistor (52A), a second correction resistor (52B) and a third correction resistor (52C) that are adjacent to each other along the second direction (Y direction),
a width of the second correction resistor (52B) along the second direction (Y direction) is less than a width of the first correction resistor (52A) along the second direction (Y direction),
a width of the third correction resistor (52C) along the second direction (Y direction) is less than the width of the second correction resistor (52B) along the second direction (Y direction), and
the first correction resistor (52A), the third correction resistor (52C) and the second correction resistor (52B) are arranged in such order and toward a side away from the main resistor unit (51) along the second direction (Y direction).

### [Note 15]

An electronic part (10), comprising:
a substrate (20), having a first main surface (21);
a first external terminal (31) and a second external terminal (32), formed on the first main surface (21) and spaced apart from each other; and
a resistive circuit portion (40), formed on the first main surface (21) and electrically connected to the first external terminal (31) and the second external terminal (32),
wherein the resistive circuit portion (40) includes:
   a first wiring (41), formed on the first main surface (21) and to which the first external terminal (31) is electrically connected;
   a second wiring (42), formed on the first main surface (21) and electrically connected to the second external terminal (32); and
   a main resistor unit (51) and a correction resistor unit (52) that are electrically connected to the first wiring (41) and the second wiring (42), extend along a first direction (X direction) in a plan view and are arranged along a second direction (Y direction) orthogonal to the first direction (X direction),
wherein the main resistor unit (51) is electrically inseparably connected to the first wiring (41) and the second wiring (42),
the correction resistor unit (52) is electrically separably connected to the first wiring (41) and the second wiring (42), and
a length (LA1) of the main resistor unit (51) along the first direction (X direction) is greater than a width (LA2) of the main resistor unit (51) along the second direction (Y direction).

The above description is merely illustrative. Those skilled in the art will recognize that many more possible combinations and permutations are possible beyond those listed for the purpose of describing the techniques of the present disclosure. This disclosure is intended to cover all alternatives, variations, and modifications falling within the scope of this disclosure, including the claims.

1. An electronic part, comprising:
a substrate, having a first main surface;
a first external terminal and a second external terminal, formed on the first main surface and spaced apart from each other; and
a resistive circuit portion, formed on the first main surface and electrically connected to the first external terminal and the second external terminal,
wherein the resistive circuit portion includes:
a first wiring, formed on the first main surface and to which the first external terminal is electrically connected;
a second wiring, formed on the first main surface and electrically connected to the second external terminal; and
a first resistor unit and a second resistor unit that are electrically connected to the first wiring and the second wiring, extend along a first direction in a plan view and are arranged along a second direction orthogonal to the first direction,
wherein a length of the second resistor unit along the first direction is less than a length of the first resistor unit along the first direction.

2. The electronic part of claim 1, wherein the length of the second resistor unit along the first direction is between about ½ and about ¾ of the length of the first resistor unit along the first direction.

3. The electronic part of claim 1, wherein
the first resistor unit is a main resistor unit that is electrically inseparably connected to the first wiring and the second wiring, and
the second resistor unit is a correction resistor unit that is electrically separably connected to the first wiring and the second wiring.

4. The electronic part of claim 1, wherein
the first resistor unit is a correction resistor unit that is electrically separably connected to the first wiring and the second wiring, and
the second resistor unit is a main resistor unit that is electrically inseparably connected to the first wiring and the second wiring.

5. The electronic part of claim 3, wherein
the correction resistor unit includes a first correction resistor, a second correction resistor and a third correction resistor that are adjacent to each other along the second direction,
the first correction resistor, the second correction resistor and the third correction resistor are arranged in an order and toward a side away from the first resistor unit along the second direction,
a width of the second correction resistor along the second direction is less than a width of the first correction resistor along the second direction, and
a width of the third correction resistor along the second direction is less than the width of the second correction resistor along the second direction.

6. The electronic part of claim 5, wherein a width of the main resistor unit along the second direction is greater than
the width of the first correction resistor along the second direction,
the width of the second correction resistor along the second direction, and
the width of the third correction resistor along the second direction.

7. The electronic part of claim 3, wherein a width of the main resistor unit along the second direction is greater than a length of the main resistor unit along the first direction.

8. The electronic part of claim 3, wherein the resistive circuit portion includes:
a first fuse, connecting the correction resistor unit and the first wiring in a separable manner; and
a second fuse, connecting the correction resistor unit and the second wiring in a separable manner.

9. The electronic part of claim 1, comprising an element stack portion, including a resistive film formed on the first main surface and a first conductive film formed on the resistive film, wherein
the first conductive film includes the first wiring and the second wiring physically separated from the first wiring, and
the first resistor unit and the second resistor unit are formed by a portion of the resistive film exposed from the first conductive film in a region between the first wiring and the second wiring.

10. The electronic part of claim 1, wherein the electronic part is a chip resistor.

11. The electronic part of claim 2, wherein the electronic part is a chip resistor.

12. The electronic part of claim 3, wherein the electronic part is a chip resistor.

13. The electronic part of claim 4, wherein the electronic part is a chip resistor.

14. The electronic part of claim 5, wherein the electronic part is a chip resistor.

15. The electronic part of claim 6, wherein the electronic part is a chip resistor.

16. The electronic part of claim 7, wherein the electronic part is a chip resistor.

17. The electronic part of claim 8, wherein the electronic part is a chip resistor.

18. The electronic part of claim 9, wherein the electronic part is a chip resistor.
